(19) United States
(12) Patent Application Publication
(10) Pub. No.: US 2026/0252433 A1
(43) Pub. Date: Aug. 27, 2026

(54) ABNORMAL CAUSE LOCALIZATION METHOD, APPARATUS, DEVICE, AND MEDIUM

(71) Applicant: Beijing Zitiao Network Technology Co., Ltd., Beijing (CN)

(72) Inventors: Guangjin ZHOU, Beijing (CN); Mingwei LI, Beijing (CN); He GUO, Beijing (CN)

(21) Appl. No.: 19/425,682

(22) Filed: Dec. 18, 2025

(30) Foreign Application Priority Data
Feb. 21, 2025 (CN) 202510199834.8

(51) Int. Cl. G06F 11/07

(52) U.S. Cl. CPC G06F 11/079

(57) ABSTRACT

The present disclosure relates to the field of computer technology, and discloses an abnormal cause localization method and apparatus, a device, and a medium. The method includes: acquiring a task log of an abnormal task and auxiliary reference information for abnormal cause localization, where the auxiliary reference information includes feature descriptions of a plurality of candidate causes and a hierarchical relationship of the candidate causes; comparing, according to the hierarchical relationship of the candidate causes, the feature descriptions of the candidate causes at respective hierarchical levels with the task log, respectively, to obtain at least one target candidate cause matching the task log; and determining, based on the target candidate cause, an abnormality cause of the abnormal task. The positioning accuracy of the abnormality cause may be improved.

### CROSS-REFERENCE TO RELATED APPLICATIONS

The present application is based on and claims priority of CN Application No. 202510199834.8, filed on Feb. 21, 2025, the disclosure of which is incorporated herein by reference in its entirety.

### TECHNICAL FIELD

The present disclosure relates to the field of computer technology, and in particular, to an abnormal cause localization method, an apparatus, a device, and a medium.

### BACKGROUND

In the execution process of some tasks, task logs are usually printed. After a task is abnormal, the cause of the task abnormality may be determined by analyzing the task log. A task refers to a series of operations performed to achieve a specific goal, such as an image processing task, a data synchronization task, an inference task, etc.

### SUMMARY

The present disclosure provides an abnormal cause localization method, an abnormal cause localization apparatus, an electronic device, a computer-readable storage medium, and a computer program product.

In a first aspect, the present disclosure provides an abnormal cause localization method, including:
acquiring a task log of an abnormal task and auxiliary reference information for abnormal cause localization, the auxiliary reference information including feature descriptions of a plurality of candidate causes and a hierarchical relationship of the candidate causes;
comparing, according to the hierarchical relationship of the candidate causes, the feature descriptions of the candidate causes at respective hierarchical levels with the task log, respectively, to obtain at least one target candidate cause matching the task log; and
determining, based on the target candidate cause, an abnormality cause of the abnormal task.

In a second aspect, the present disclosure provides an abnormal cause localization apparatus, including:
an information acquiring module, configured to acquire a task log of an abnormal task and auxiliary reference information for abnormal cause localization, the auxiliary reference information including feature descriptions of a plurality of candidate causes and a hierarchical relationship of the candidate causes;
a comparing module, configured to compare, according to the hierarchical relationship of the candidate causes, the feature descriptions of the candidate causes at respective hierarchical levels with the task log, respectively, to obtain at least one target candidate cause matching the task log; and
an abnormality localizing module, configured to determine, based on the target candidate cause, an abnormality cause of the abnormal task.

In a third aspect, the present disclosure provides an electronic device, including: a memory and a processor, the memory and the processor being communicatively connected to each other, the memory having computer instructions stored thereon, the processor, by executing the computer instructions, implementing the method described above.

In a fourth aspect, the present disclosure provides a computer-readable storage medium having computer instructions stored thereon, the computer instructions being configured to cause a computer to perform the method described above.

In a fifth aspect, the present disclosure provides a computer program product including computer instructions, the computer instructions being configured to cause a computer to perform the method described above.

### BRIEF DESCRIPTION OF THE DRAWINGS

In order to more clearly illustrate the technical solutions in the specific embodiments of the present disclosure or in the related art, the following will briefly introduce the drawings that need to be used in the description of the specific embodiments or the related art. Obviously, the drawings in the following description are some embodiments of the present disclosure. For those of ordinary skill in the art, other drawings may be obtained based on these drawings without creative efforts.

FIG. 1 is a schematic diagram of some abnormality cause display pages;

FIG. 2 is a schematic flowchart of an abnormal cause localization method provided by some embodiments of the present disclosure;

FIG. 3 is an example of auxiliary reference information provided by some embodiments of the present disclosure;

FIG. 4 is an example of auxiliary reference information provided by some other embodiments of the present disclosure;

FIG. 5 is an example of auxiliary reference information provided by some other embodiments of the present disclosure;

FIG. 6 is an example of auxiliary reference information provided by some other embodiments of the present disclosure;

FIG. 7 is an example of auxiliary reference information provided by some other embodiments of the present disclosure;

FIG. 8 is a schematic block diagram of an abnormal cause localization apparatus provided by some embodiments of the present disclosure; and

FIG. 9 is a schematic structural diagram of an electronic device provided by some embodiments of the present disclosure.

### DETAILED DESCRIPTION OF EMBODIMENTS

In order to make the purpose, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are part of the embodiments of the present disclosure, but not all of them. Based on the embodiments in the present disclosure, all other embodiments obtained by those skilled in the art without creative efforts belong to the protection scope of the present disclosure.

Embodiments of the present disclosure will be described in more detail below with reference to the drawings. Although certain embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only used for exemplary purposes, and are not used to limit the protection scope of the present disclosure.

In the description of the embodiments of the present disclosure, the terms “include” and similar terms should be understood as open-ended inclusions, that is, “include but not limited to”. The term “based on” should be understood as “at least partially based on”. The term “one embodiment” or “the embodiment” should be understood as “at least one embodiment”. The term “some embodiments” should be understood as “at least some embodiments”. Other definitions, either explicit or implicit, may be included below.

Herein, unless otherwise specified, “performing a step in response to A” does not mean that the step is performed immediately after “A”, but may include one or more intermediate steps.

It may be understood that the data involved in the technical solution (including but not limited to the data itself, acquisition, use, storage or deletion of the data) should comply with the requirements of corresponding laws, regulations and related provisions.

It may be understood that before using the technical solutions disclosed in the embodiments of the present disclosure, the type, range of use, use scenarios, etc. of information involved in the present disclosure should be informed to a related user and the authorization of the related user should be obtained through an appropriate manner in accordance with relevant laws and regulations, where the related user may include any type of subject of rights, such as an individual, an enterprise, or a group.

For example, in response to receiving an active request from a user, prompt information is sent to the related user to clearly prompt the related user that the requested operation will need to obtain and use the information of the related user, so that the related user may independently choose whether to provide the information to software or hardware, such as an electronic device, an application, a server or a storage medium, that performs the operations of the technical solutions of the present disclosure based on the prompt information.

As an optional but non-limiting implementation, in response to receiving the active request from the related user, the manner of sending the prompt information to the related user may be, for example, a pop-up window, in which the prompt information may be presented in text. In addition, the pop-up window may also carry a selection control for the user to select “agree” or “disagree” to provide the information to the electronic device.

It may be understood that the above process of notifying and obtaining user authorization is only illustrative, and does not limit the implementations of the present disclosure. Other manners that satisfy the relevant laws and regulations may also be applied to the implementations of the present disclosure.

At present, in some technologies, automatic analysis of task logs may be realized, and corresponding abnormality causes may be obtained. In this way, manpower input may be greatly reduced. However, the abnormality causes located in these technologies have the problem of low accuracy.

Therefore, a method with higher positioning accuracy is urgently needed.

In the technical solution of some embodiments of the present disclosure, since the auxiliary reference information includes the feature descriptions of the plurality of candidate causes and the hierarchical relationship of the candidate causes, when comparing the feature descriptions of the candidate causes at respective hierarchical levels with the task log, respectively, according to the hierarchical relationship of the candidate causes, at least one target candidate cause matching the task log may be found, even if the task log does not include abnormality causes of all granularity, and then the abnormality cause of the abnormal task may be located based on the target candidate cause. In this way, the problem of abnormality cause localization failure or low localization accuracy in some technologies as the task log does not include abnormality causes of all granularity is avoided. Compared with some technologies, the technical solution of the present disclosure achieves the purpose of improving the positioning accuracy.

An abnormal task refers to a task that runs abnormally, such as a task that prompts a failure in execution, a task that is in a waiting state for a long time, and the like. The abnormality cause of the abnormal task may include a coarse-grained abnormality cause and a fine-grained abnormality cause. The fine-grained abnormality cause is a further division of the coarse-grained abnormality cause, and each coarse-grained abnormality cause may include one or more fine-grained abnormality causes. For example, the coarse-grained abnormality cause “version conflict” may further include two fine-grained abnormality causes: “software version conflict” and “software operating environment version conflict”. For another example, the coarse-grained abnormality cause “parameter parsing failure” may further include three fine-grained abnormality causes: “a parameter parsing failure”, “b parameter parsing failure”, and “c parameter parsing failure”. In an actual task running process, a specific abnormality cause of the abnormal task may be one or more of the fine-grained abnormality causes under the coarse-grained abnormality cause. For example, when the coarse-grained abnormality cause of the abnormal task A is “parameter parsing failure”, the specific abnormality cause of the abnormal task A may be one of “a parameter parsing failure”, “b parameter parsing failure”, and “c parameter parsing failure”.

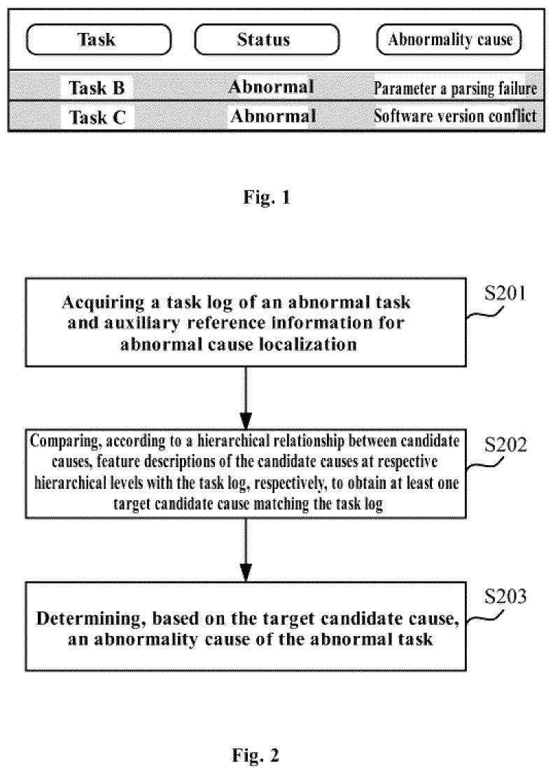

At present, in some technologies, the abnormality cause of an abnormal task may be automatically located, and a detection result may be displayed through an abnormality cause display page. For ease of understanding, referring to FIG. 1 together, it is a schematic diagram of some abnormality cause display pages. In FIG. 1, abnormality causes corresponding to abnormal tasks B and C are displayed. In this way, technicians only need to view the abnormality cause display page to locate the abnormality cause of each abnormal task, without manually analyzing the abnormality cause, thereby greatly reducing the input of manpower cost and improving the localization efficiency of the abnormality cause.

Specifically, in the above technologies, the automatic detection of the abnormality cause is mainly realized based on technologies such as data event tracking, intelligent identification, and data matching. The data event tracking requires intruding into task program code, which leads to high development costs and is prone to new program code problems. The intelligent identification requires high server resource costs. Therefore, the applicability of the data event tracking and the intelligent identification is not high enough. The data matching is mainly to pre-establish an abnormality cause set of an abnormal task based on possible abnormality causes of the abnormal task, and then compare each abnormality cause in the abnormality cause set with a task log of the abnormal task, respectively. The task log may include a plurality of log records generated in a chronological order, and these log records usually include the abnormality cause of the abnormal task. Therefore, for any abnormality cause in the abnormality cause set, if there is content matching the abnormality cause in the task log of the abnormal task, the abnormality cause may be used as the abnormality cause of the abnormal task. For example, assuming that the abnormality cause set of the abnormal task A includes “network connection interruption”, “data parsing failure”, and “version conflict”, then “network connection interruption”, “data parsing failure”, and “version conflict” may be compared with the task log of the abnormal task A, respectively, in turn. Take “network connection interruption” as an example. If there is content matching “network connection interruption” in the task log of the abnormal task A, it is considered that the abnormality cause of the abnormal task A is “network connection interruption”. If there is no content matching “network connection interruption” in the task log of the abnormal task A, it is considered that the abnormality cause of the abnormal task A is not “network connection interruption”. This data matching technology relies on the task log generated during the task running process, and has low cost and high applicability, but the problem of abnormality cause localization failure or low abnormality cause localization accuracy often occurs. It is found through analysis that the reason for this problem is that the abnormality cause set in these technologies does not match the task log of the abnormal task well enough. Specifically, the abnormality cause included in the task log of the abnormal task may be mainly divided into the following two cases:
1) Both the coarse-grained abnormality cause of the abnormal task and a specific fine-grained abnormality cause that leads to the abnormality of the abnormal task are included. For example, in the task log of the abnormal task A, the coarse-grained abnormality cause is “parameter parsing failure”, and the fine-grained abnormality cause is “a parameter parsing failure”, indicating that the specific cause of the abnormality of the abnormal task A is “a parameter parsing failure”. For another example, in the task log of the abnormal task B, the coarse-grained abnormality cause is “parameter parsing failure”, and the fine-grained abnormality cause is “b parameter parsing failure”, indicating that the specific cause of the abnormality of the abnormal task B is “b parameter parsing failure”. In this way, based on the coarse-grained abnormality cause in the task log, a fuzzy cause of the task abnormality may be determined, and based on the fine-grained abnormality cause in the task log, the specific cause of the task abnormality may be determined.
2) Only one of the coarse-grained abnormality cause and the fine-grained abnormality cause is included. For example, the task log of the abnormal task C only includes the coarse-grained abnormality cause “parameter parsing failure”, and does not include the specific fine-grained abnormality cause. For another example, the task log of the abnormal task D only includes the fine-grained abnormality cause “b parameter parsing failure”, and does not include the coarse-grained abnormality cause.

However, in some technologies, the pre-established abnormality cause set only includes the coarse-grained abnormality cause or the fine-grained abnormality cause, which will lead to the problem of abnormality cause localization failure or low abnormality cause localization accuracy. For example, in the case that the abnormality cause set only includes the coarse-grained abnormality cause, even if the task log of the abnormal task further includes the fine-grained abnormality cause, the fine-grained abnormality cause of the abnormal task cannot be obtained by means of comparison, which leads to the problem of low abnormality cause localization accuracy. For another example, in the case that the abnormality cause set only includes the fine-grained abnormality cause, if the task log of the abnormal task only includes the coarse-grained abnormality cause, the fine-grained abnormality cause in the abnormality cause set does not match the task log, resulting in the problem of abnormality cause localization failure.

In view of this, the present disclosure provides an abnormal cause localization method, which may solve the above problem and improve the positioning accuracy of an abnormality cause. The abnormal cause localization method may be applied to an electronic device. The electronic device may include, but is not limited to, a tablet computer, a notebook computer, a desktop computer, a server, etc. Referring to FIG. 2 together, it is a schematic flowchart of an abnormal cause localization method provided by some embodiments of the present disclosure. In FIG. 2, the abnormal cause localization method may include the following steps.

Step S201, acquiring a task log of an abnormal task and auxiliary reference information for abnormal cause localization, the auxiliary reference information including feature descriptions of a plurality of candidate causes and a hierarchical relationship of the candidate causes.

In this embodiment, a log file of the abnormal task may be saved in a device that runs the abnormal task. The task log of the abnormal task may be read from the log file.

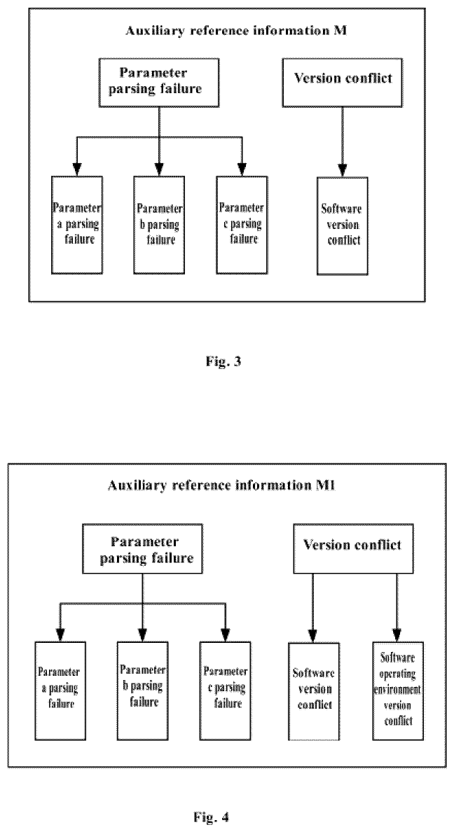

Each abnormal task may have its own corresponding auxiliary reference information. For any auxiliary reference information corresponding to an abnormal task, the candidate causes in the auxiliary reference information may include a historical abnormality cause of the corresponding task, a cause obtained after a technician refines and summarizes the historical abnormality cause of the corresponding task, and an abnormality cause that has not occurred in the corresponding task and is added by the technician according to experience. The candidate causes may include coarse-grained abnormality causes and fine-grained abnormality causes. The hierarchical relationship of the candidate causes is used to represent a parent-child relationship between a coarse-grained candidate cause and a fine-grained candidate cause. For example, it is assumed that an image processing task M has experienced 5 abnormalities historically. Among these 5 abnormalities, a coarse-grained abnormality cause of the first abnormality is “parameter parsing failure”, and a fine-grained abnormality cause is “parameter a parsing failure”; a coarse-grained abnormality cause of the second abnormality is “parameter parsing failure”, and a fine-grained abnormality cause is “parameter b parsing failure”; a coarse-grained abnormality cause of the third abnormality is “parameter parsing failure”, and a fine-grained abnormality cause is “parameter a parsing failure”; a coarse-grained abnormality cause of the fourth abnormality is “version conflict”, and a fine-grained abnormality cause is “software version conflict”; a coarse-grained abnormality cause of the fifth abnormality is “parameter parsing failure”, and a fine-grained abnormality cause is “parameter c parsing failure”. Then, based on the historical abnormality causes of the image processing task M, the auxiliary reference information M shown in FIG. 3 may be obtained.

In FIG. 3, in an arrow direction, “parameter b parsing failure” and “version conflict” are candidate causes at a first hierarchical level, and “parameter a parsing failure”, “parameter b parsing failure”, “parameter c parsing failure”, “software version conflict”, and “software operating environment version conflict” are candidate causes at a second hierarchical level.

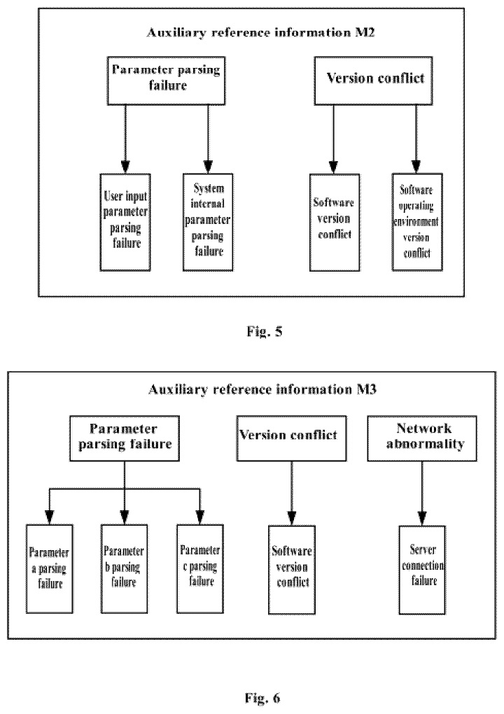

Based on FIG. 3, if a technician newly adds “software operating environment version conflict” under the coarse-grained abnormality cause “version conflict” according to experience, the auxiliary reference information M1 shown in FIG. 4 may be obtained. Alternatively, if the technician refines parameters a and b into user input parameters and refines the parameter c into a system internal parameter, the auxiliary reference information M2 shown in FIG. 5 may be obtained.

When the image processing task M becomes an abnormal task, one of the auxiliary reference information in FIG. 3 to FIG. 5 may be used as auxiliary reference information for locating the abnormality cause.

In other embodiments, the auxiliary reference information may also be obtained based on historical abnormality causes of a plurality of tasks. In this case, if any two tasks have the same historical abnormality cause, only one candidate cause may be saved in the auxiliary reference information. For example, it is assumed that, on the basis of the above image processing task M, an image download task N has experienced 3 abnormalities historically, a coarse-grained abnormality cause of the first abnormality is “parameter parsing failure”, and a fine-grained abnormality cause is “parameter a parsing failure”; a coarse-grained abnormality cause of the second abnormality is “parameter parsing failure”, and a fine-grained abnormality cause is “parameter b parsing failure”; a coarse-grained abnormality cause of the third abnormality is “network abnormality”, and a fine-grained abnormality cause is “server connection failure”. Then, based on the historical abnormality causes of the image processing task M and the image download task N, the auxiliary reference information M3 shown in FIG. 6 may be obtained.

When the auxiliary reference information is obtained based on the historical abnormality causes of the plurality of tasks, if the plurality of tasks become abnormal tasks, these abnormal tasks may correspond to the same auxiliary reference information.

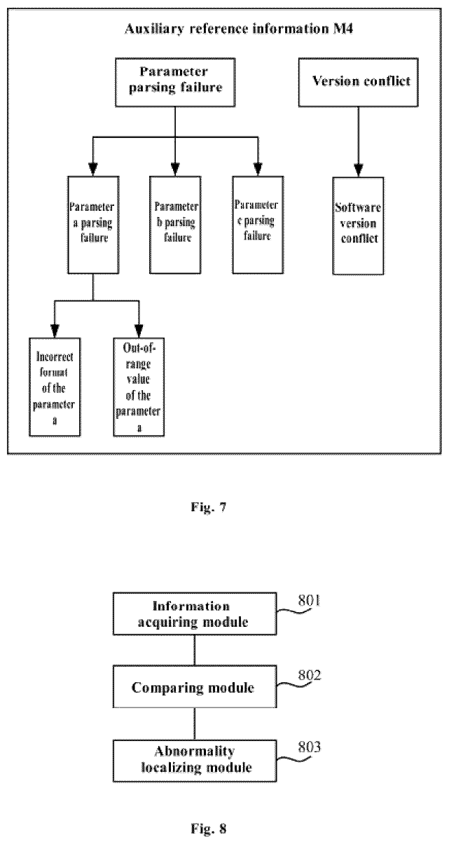

Further, in the auxiliary reference information, the hierarchy of the candidate causes may be more than two levels, for example, three levels or four levels. When the hierarchy of the candidate causes is more than two levels, it indicates that the fine-grained candidate cause has a finer-grained candidate cause. For example, on the basis of FIG. 3, assuming that the reason for the failure in parsing the parameter a may include an incorrect format of the parameter a and an out-of-range value of the parameter a, the auxiliary reference information M4 shown in FIG. 7 may be obtained. In FIG. 7, “incorrect format of the parameter a” and “out-of-range value of the parameter a” are candidate causes at a third hierarchical level.

Step S202: comparing, according to the hierarchical relationship of the candidate causes, the feature descriptions of the candidate causes at respective hierarchical levels with the task log, respectively, to obtain at least one target candidate cause matching the task log.

Specifically, the feature description of the candidate cause is a cause description of the candidate cause. For example, in FIG. 3, the feature description corresponding to the candidate cause in the upper left corner is “parameter parsing failure”, and the feature description corresponding to the candidate cause in the upper right corner is “version conflict”. And so on.

In this embodiment, for any candidate cause, after comparing the feature description of the candidate cause with the task log, if one of the following conditions is met, it may be determined that the candidate cause matches the task log:
there is a complete or partial feature description of the candidate cause in the task log; and
at least part of log records in the task log have the same semantics as the feature description of the candidate cause.

When there is the complete feature description of the candidate cause in the task log, it indicates that when the auxiliary reference information is generated, the historical abnormality cause in the task log is directly used as the candidate cause in the auxiliary reference information. When there is the partial feature description of the candidate cause in the task log, it indicates that when the auxiliary reference information is generated, the historical abnormality cause in the task log is summarized and refined. When at least part of the log records in the task log have the same semantics as the feature description of the candidate cause, it indicates that when the auxiliary reference information is generated, the historical abnormality cause in the task log is summarized and refined, or a new abnormality cause that does not exist in the historical abnormality cause is added. Therefore, determining whether the feature description of the candidate cause matches the task log based on the above conditions may be relatively accurate and comprehensive, and the probability of misjudgment may be reduced.

It may be learned from the above related description of the task log that since the task log may include both the coarse-grained abnormality cause and the fine-grained abnormality cause, or may include one of the coarse-grained abnormality cause and the fine-grained abnormality cause, under normal circumstances, at least one target candidate cause may be obtained when comparing the feature descriptions of the candidate causes at respective hierarchical levels with the task log, respectively.

For example, based on FIG. 7, it is assumed that the task log includes both the coarse-grained abnormality cause and the fine-grained abnormality cause. When comparing each candidate cause at the first hierarchical level with the task log, if first content in the task log matches the candidate cause “parameter parsing failure”, and there is no content in the task log matching the candidate cause “version conflict”, then the candidate cause “parameter parsing failure” may be used as a first target candidate cause. Similarly, when comparing each candidate cause at the second hierarchical level with the task log, a second target candidate cause may be obtained, and when comparing each candidate cause at the third hierarchical level with the task log, a third target candidate cause may be obtained.

For another example, based on FIG. 7, it is assumed that the task log only includes the coarse-grained abnormality cause, then when comparing each candidate cause at the first hierarchical level with the task log, the first target candidate cause may be obtained, and when comparing each candidate cause at the second hierarchical level and the third hierarchical level with the task log, no target candidate cause may be obtained.

For another example, based on FIG. 7, it is assumed that the task log only includes the fine-grained abnormality cause, then when comparing each candidate cause at the first hierarchical level with the task log, no target candidate cause may be obtained, and when comparing each candidate cause at the second hierarchical level and the third hierarchical level with the task log, two target candidate causes may be obtained.

Further, generally, in the case of a task abnormality, the fine-grained abnormality cause is first printed in the task log, and the coarse-grained abnormality cause is then printed in the task log. That is, the fine-grained abnormality cause may be located at a front position of the task log, and the coarse-grained abnormality cause may be located at a back position of the task log. Therefore, when comparing the feature descriptions of the candidate causes at respective hierarchical levels with the task log, respectively, the log records in the task log may be compared with the feature descriptions of the candidate causes at respective hierarchical levels, in turn, according to an order of generation time from back to front. In this way, the candidate cause at the first hierarchical level may be found first, and the search efficiency may be improved.

Step S203: determining, based on the target candidate cause, an abnormality cause of the abnormal task.

Specifically, in the case that only one target candidate cause is obtained in step S202, the target candidate cause may be used as the abnormality cause of the abnormal task. That is, in the case that the task log only includes the coarse-grained abnormality cause, the target candidate cause (that is, the coarse-grained abnormality cause) found at the first hierarchical level is directly used as the abnormality cause; in the case that the task log only includes the fine-grained abnormality cause, the target candidate cause (that is, the fine-grained abnormality cause) found at the second hierarchical level or the third hierarchical level is directly used as the abnormality cause.

When a plurality of target candidate causes at different hierarchical levels are obtained in step 202, since the target candidate cause at a lower hierarchical level is a child candidate cause of the target candidate cause at a higher hierarchical level, and the target candidate cause at the lower hierarchical level is a further subdivision of the candidate cause at the higher hierarchical level, the target candidate cause at the lower hierarchical level may reflect the abnormality cause of the abnormal task more accurately. Therefore, the target candidate cause at the lowest hierarchical level may be found among the plurality of target candidate causes at different hierarchical levels, and the target candidate cause at the lowest hierarchical level may be used as the abnormality cause of the abnormal task. In this way, the obtained abnormality cause may be more accurate.

In summary, in the technical solution of some embodiments of the present disclosure, since the auxiliary reference information includes the feature descriptions of the plurality of candidate causes and the hierarchical relationship of the candidate causes, when comparing the feature descriptions of the candidate causes at respective hierarchical levels with the task log, respectively, according to the hierarchical relationship of the candidate causes, at least one target candidate cause matching the task log may be found, even if the task log does not include abnormality causes of all granularity, and then the abnormality cause of the abnormal task may be located based on the target candidate cause. In this way, the problem of abnormality cause localization failure or low localization accuracy in some technologies when the task log does not include abnormality causes of all granularity is avoided. Compared with some technologies, the technical solution of the present disclosure achieves the purpose of improving the positioning accuracy.

In some embodiments, if no target candidate cause matching the task log is found in the auxiliary reference information, it indicates that a new abnormality cause that is not included in the auxiliary reference information has occurred. In this case, prompt information representing that the abnormality cause localization fails may be generated. Based on the prompt information, a technician may supplement a new candidate cause in the auxiliary reference information based on the new abnormality cause in the task log, so that the abnormality cause of the abnormal task may be automatically located when the abnormality cause occurs again. By continuously improving the auxiliary reference information, the automation level of abnormality cause localization may be further improved.

In some embodiments, the comparing, according to the hierarchical relationship between the candidate causes, the feature descriptions of the candidate causes at respective hierarchical levels with the task log, respectively, to obtain at least one target candidate cause matching the task log in step S202 may specifically include:
searching for a first candidate cause at a first hierarchical level;
comparing a feature description of the first candidate cause with the task log, respectively, to obtain a first target candidate cause matching the task log;
searching for, among second candidate causes at a second hierarchical level, a child candidate cause located under the first target candidate cause; and
comparing a feature description of the child candidate cause with the task log to obtain a second target candidate cause matching the task log.

The first hierarchical level and the second hierarchical level may be any two adjacent upper and lower hierarchical levels. For example, the first hierarchical level is hierarchical level one, and the second hierarchical level is hierarchical level two. For another example, the first hierarchical level is hierarchical level two, and the second hierarchical level is hierarchical level three.

After the first target candidate cause is found at the first hierarchical level, it indicates that the general direction of the abnormality cause has been determined. In this case, a finer abnormality cause may be directly found at the second hierarchical level among the child candidate causes under the first target candidate cause. In this way, the data processing volume may be reduced. For example, with reference to FIG. 3, it is assumed that the first target candidate cause found at hierarchical level one is “parameter parsing failure”, then at hierarchical level two, the candidate causes “parameter a parsing failure”, “parameter b parsing failure”, and “parameter c parsing failure” may be directly compared with the task log in turn, and the candidate cause “software version conflict” is not compared with the task log. In this way, the purpose of reducing the data processing volume is achieved.

In some embodiments, if there is no first target candidate cause matching the task log in the first candidate cause, it indicates that the auxiliary reference information does not include the coarse-grained abnormality cause, but may include the fine-grained abnormality cause. The feature descriptions of the second candidate causes at the second hierarchical level may be compared with the task log, respectively, to search for the second target candidate cause matching the task log. In this way, the problem of missing the search for the abnormality cause may be avoided, and the accuracy of searching for the abnormality cause may be ensured.

In some embodiments, the acquiring a task log of an abnormal task in step S201 may include:
acquiring a preset number of first log records from a last generated log record; and
if, after the feature descriptions of the candidate causes at respective hierarchical levels are compared with the first log records, any of the following conditions is met, then continuing to acquire second log records generated before the first log records:
no target candidate cause matching the first log records is found; and
a target candidate cause matching the first log records is found, and the target candidate cause includes a child candidate cause.

Specifically, after the feature descriptions of the candidate causes at respective hierarchical levels are compared with the first log records, if any of the above conditions is met, it indicates that the candidate cause at the bottommost level has not been found. In this case, it is necessary to continue to acquire the second log records and search for the candidate cause at the bottommost level, thereby ensuring that the finally determined abnormality cause may be the most precise, and improving the accuracy of the abnormality cause.

In some embodiments, if, after the feature descriptions of the candidate causes at respective hierarchical levels are compared with the first log records, the target candidate cause matching the first log records is found, and the target candidate cause does not include the child candidate cause, in this case, it indicates that the candidate cause at the bottommost level has been found, and therefore, the acquisition of the second log records generated before the first log records may be stopped, thereby reducing the data processing volume.

So far, the entire description of the solution of the present disclosure is completed.

Referring to FIG. 8 together, it is a schematic block diagram of an abnormal cause localization apparatus provided by some embodiments of the present disclosure. In FIG. 8, the abnormal cause localization apparatus includes:
an information acquiring module 801, configured to acquire a task log of an abnormal task and auxiliary reference information for abnormal cause localization, the auxiliary reference information including feature descriptions of a plurality of candidate causes and a hierarchical relationship of the candidate causes;
a comparing module 802, configured to compare, according to the hierarchical relationship of the candidate causes, the feature descriptions of the candidate causes at respective hierarchical levels with the task log, respectively, to obtain at least one target candidate cause matching the task log; and
an abnormality localizing module 803, configured to determine, based on the target candidate cause, an abnormality cause of the abnormal task.

In some embodiments, the comparing module 802 is further configured to:
search for a first candidate cause at a first hierarchical level;
compare a feature description of the first candidate cause with the task log, respectively, to obtain a first target candidate cause matching the task log;
search for, among second candidate causes at a second hierarchical level, a child candidate cause located under the first target candidate cause; and
compare a feature description of the child candidate cause with the task log to obtain a second target candidate cause matching the task log.

In some embodiments, the comparing module 802 is further configured to:
if there is no first target candidate cause matching the task log in the first candidate cause, then compare feature descriptions of each of the second candidate causes at the second hierarchical level with the task log, respectively, to search for the second target candidate cause matching the task log.

In some embodiments, in the case that there are a plurality of target candidate causes at different hierarchical levels, a target candidate cause at a lower hierarchical level is a child candidate cause of a target candidate cause at a higher hierarchical level; the abnormality localizing module 803 is specifically configured to:
search for a target candidate cause at a lowest hierarchical level among the plurality of target candidate causes at different hierarchical levels, and use the target candidate cause at the lowest hierarchical level as the abnormality cause of the abnormal task.

In some embodiments, the task log includes a plurality of log records generated in a chronological order; the information acquiring module 801 is further configured to:
acquire a preset number of first log records from a last generated log record; and
if, after the feature descriptions of the candidate causes at respective hierarchical levels are compared with the first log records, any of the following conditions is met, then continue to acquire second log records generated before the first log records:
no target candidate cause matching the first log records is found; and
a target candidate cause matching the first log records is found, and the target candidate cause includes a child candidate cause.

In some embodiments, the comparing module 802 is further configured to:
if, after the feature descriptions of the candidate causes at respective hierarchical levels are compared with the first log records, the target candidate cause matching the first log records is found, and the target candidate cause does not include the child candidate cause, then stop acquiring the second log records generated before the first log records.

In some embodiments, for any candidate cause, the comparing module 802, after comparing the feature description of the candidate cause with the task log, determines that the candidate cause matches the task log, if one of the following conditions is met:
there is a complete or partial feature description of the candidate cause in the task log; and
at least part of log records in the task log have the same semantics as the feature description of the candidate cause.

In some embodiments, the task log includes a plurality of log records generated in a chronological order; the comparing module 802 is specifically configured to:
compare each of the log records in the task log with the feature descriptions of the candidate causes at respective hierarchical levels, in turn, according to an order of generation time from back to front.

In some embodiments, the comparing module 802 is further configured to:
if no target candidate cause matching the task log is found in the auxiliary reference information, then generate prompt information representing that the abnormality cause localization fails.

The configuration apparatus in this embodiment is presented in a form of functional units, and the unit here refers to an ASIC (Application Specific Integrated Circuit) circuit, a processor and a memory that execute one or more software or fixed programs, and/or other devices that may provide the above functions.

The abnormal cause localization apparatus of the present disclosure has the same beneficial effects as the above abnormal cause localization method, which will not be repeated here.

An embodiment of the present disclosure further provides an electronic device having the abnormal cause localization apparatus shown in FIG. 8.

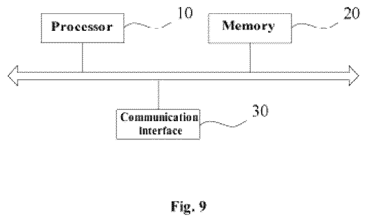

Referring to FIG. 9 together, it is a schematic structural diagram of an electronic device provided by some embodiments of the present disclosure. As shown in FIG. 9, the electronic device includes: one or more processors 10, a memory 20, and interfaces for connecting various components, including high-speed interfaces and low-speed interfaces. The components communicate with each other using different buses and may be installed on a common main board or in other ways as needed. The processor may process instructions executed within the electronic device, including instructions stored in or on the memory to display graphical information of GUI on an external input/output apparatus (such as a display device coupled to the interface). In some optional implementations, if required, multiple processors and/or buses may be used with multiple memories and multiple memories. Similarly, multiple electronic devices may be connected, and each device provides some necessary operations (for example, as a server array, a group of blade servers, or a multi-processor system). In FIG. 9, one processor 10 is taken as an example.

The processor 10 may be a central processing unit, a network processor or a combination thereof. The processor 10 may further include a hardware chip. The above hardware chip may be an application specific integrated circuit, a programmable logic device or a combination thereof. The above programmable logic device may be a complex programmable logic device, a field programmable logic gate array, a generic array logic, or any combination thereof.

The memory 20 has instructions executable by at least one processor 10 stored thereon, so that the at least one processor 10 executes the method shown in the above embodiments.

The memory 20 may include a program storage area and a data storage area, where the program storage area may store an operating system and an application program required by at least one function; the data storage area may store data created according to the use of the electronic device, and so on. In addition, the memory 20 may include a high-speed random access memory or a non-transitory memory, such as at least one magnetic disk storage device, a flash memory device, or other non-transitory solid-state storage devices. In some optional implementations, the memory 20 optionally includes memories remotely provided with respect to the processor 10, and these remote memories may be connected to the electronic device through a network. Examples of the above network include, but are not limited to, Internet, an intranet, a local area network, a mobile communication network, and a combination thereof.

The memory 20 may include a volatile memory, such as a random access memory; the memory may also include a non-volatile memory, such as a flash memory, a hard disk or a solid state disk; the memory 20 may also include a combination of the above kinds of memories.

The electronic device further includes a communication interface 30, which is used for the electronic device to communicate with other devices or communication networks.

An embodiment of the present disclosure further provides a computer-readable storage medium. The method according to the embodiment of the present disclosure may be implemented in hardware and firmware, or implemented as being recordable in a storage medium, or implemented as computer codes originally stored in a remote storage medium or a non-transitory machine-readable storage medium and to be stored in a local storage medium that is downloaded through a network, so that the method described herein may be stored in such software on a storage medium using a general-purpose computer, a dedicated processor, or programmable or dedicated hardware. The storage medium may be a magnetic disk, an optical disk, a read-only memory, a random access memory, a flash memory, a hard disk or a solid state disk, and the like; further, the storage medium may further include a combination of the above kinds of memories. It may be understood that the computer, the processor, the microprocessor controller or the programmable hardware includes a storage component that may store or receive software or computer codes, and when the software or computer codes are accessed and executed by the computer, the processor or the hardware, the method shown in the above embodiments is implemented.

A part of the present disclosure may be applied as a computer program product, such as computer program instructions, which, when executed by a computer, may invoke or provide the method and/or technical solution according to the present disclosure through the operation of the computer. Those skilled in the art should understand that the computer program instructions exist in a computer-readable medium in a form including, but not limited to, a source file, an executable file, an installation package file, etc. Accordingly, the computer program instructions are executed by the computer in a manner including, but not limited to, the computer directly executes the instructions, or the computer compiles the instructions and then executes a corresponding compiled program, or the computer reads and executes the instructions, or the computer reads and installs the instructions and then executes a corresponding installed program. Here, the computer-readable medium may be any available computer-readable storage medium or communication medium accessible by the computer.

Although the embodiments of the present disclosure are described in conjunction with the drawings, those skilled in the art may make various modifications and variations without departing from the spirit and scope of the present disclosure, and such modifications and variations fall within the scope defined by the appended claims.

1. An abnormal cause localization method, comprising:
acquiring a task log of an abnormal task and auxiliary reference information for abnormal cause localization, the auxiliary reference information comprising feature descriptions of a plurality of candidate causes and a hierarchical relationship of the candidate causes;
comparing, according to the hierarchical relationship of the candidate causes, the feature descriptions of the candidate causes at respective hierarchical levels with the task log, respectively, to obtain at least one target candidate cause matching the task log; and
determining, based on the target candidate cause, an abnormality cause of the abnormal task.

2. The method of claim 1, wherein the comparing, according to the hierarchical relationship of the candidate causes, the feature descriptions of the candidate causes at respective hierarchical levels with the task log, respectively, to obtain at least one target candidate cause matching the task log comprises:
searching for a first candidate cause at a first hierarchical level;
comparing a feature description of the first candidate cause with the task log, respectively, to obtain a first target candidate cause matching the task log;
searching for, among second candidate causes at a second hierarchical level, a child candidate cause located under the first target candidate cause; and
comparing a feature description of the child candidate cause with the task log to obtain a second target candidate cause matching the task log.

3. The method of claim 2, further comprising:
in response to there being no first target candidate cause matching the task log in the first candidate cause, then comparing feature descriptions of each of the second candidate causes at the second hierarchical level with the task log, respectively, to search for the second target candidate cause matching the task log.

4. The method of claim 1, wherein in a case that there are a plurality of target candidate causes at different hierarchical levels, a target candidate cause at a lower hierarchical level is a child candidate cause of a target candidate cause at a higher hierarchical level;
the determining, based on the target candidate cause, an abnormality cause of the abnormal task comprises:
searching for a target candidate cause at a lowest hierarchical level among the plurality of target candidate causes at different hierarchical levels, and using the target candidate cause at the lowest hierarchical level as the abnormality cause of the abnormal task.

5. The method of claim 1, wherein the task log comprises a plurality of log records generated in a chronological order;
the acquiring a task log of an abnormal task comprises:
acquiring a preset number of first log records from a last generated log record; and
in response to, after the feature descriptions of the candidate causes at respective hierarchical levels are compared with the first log records, any of the following conditions being met, then continuing to acquire second log records generated before the first log records:
no target candidate cause matching the first log records is found; and
a target candidate cause matching the first log records is found, and the target candidate cause comprises a child candidate cause.

6. The method of claim 5, further comprising:
in response to, after the feature descriptions of the candidate causes at respective hierarchical levels are compared with the first log records, the target candidate cause matching the first log records being found, and the target candidate cause not comprising the child candidate cause, then stopping acquiring the second log records generated before the first log records.

7. The method of claim 1, wherein for any candidate cause, after the feature description of the candidate cause is compared with the task log, the candidate cause is determined to match the task log, if one of the following conditions is met:
there is a complete or partial feature description of the candidate cause in the task log; and
at least part of log records in the task log have the same semantics as the feature description of the candidate cause.

8. The method of claim 1, wherein the task log comprises a plurality of log records generated in a chronological order;
the comparing the feature descriptions of the candidate causes at respective hierarchical levels with the task log, respectively, comprises:
comparing each of the log records in the task log with the feature descriptions of the candidate causes at respective hierarchical levels, in turn, according to an order of generation time from back to front.

9. The method of claim 1, further comprising:
in response to no target candidate cause matching the task log being found in the auxiliary reference information, then generating prompt information representing that the abnormal cause localization fails.

10. An electronic device, comprising:
a memory and a processor, the memory and the processor being communicatively connected to each other, the memory having computer instructions stored thereon, the processor, by executing the computer instructions, implementing an abnormal cause localization method, comprising:
acquiring a task log of an abnormal task and auxiliary reference information for abnormal cause localization, the auxiliary reference information comprising feature descriptions of a plurality of candidate causes and a hierarchical relationship of the candidate causes;
comparing, according to the hierarchical relationship of the candidate causes, the feature descriptions of the candidate causes at respective hierarchical levels with the task log, respectively, to obtain at least one target candidate cause matching the task log; and
determining, based on the target candidate cause, an abnormality cause of the abnormal task.

11. The device of claim 10, wherein the comparing, according to the hierarchical relationship of the candidate causes, the feature descriptions of the candidate causes at respective hierarchical levels with the task log, respectively, to obtain at least one target candidate cause matching the task log comprises:
searching for a first candidate cause at a first hierarchical level;
comparing a feature description of the first candidate cause with the task log, respectively, to obtain a first target candidate cause matching the task log;
searching for, among second candidate causes at a second hierarchical level, a child candidate cause located under the first target candidate cause; and
comparing a feature description of the child candidate cause with the task log to obtain a second target candidate cause matching the task log.

12. The device of claim 11, further comprising:
in response to there being no first target candidate cause matching the task log in the first candidate cause, then comparing feature descriptions of each of the second candidate causes at the second hierarchical level with the task log, respectively, to search for the second target candidate cause matching the task log.

13. The device of claim 10, wherein in a case that there are a plurality of target candidate causes at different hierarchical levels, a target candidate cause at a lower hierarchical level is a child candidate cause of a target candidate cause at a higher hierarchical level;
the determining, based on the target candidate cause, an abnormality cause of the abnormal task comprises:
searching for a target candidate cause at a lowest hierarchical level among the plurality of target candidate causes at different hierarchical levels, and using the target candidate cause at the lowest hierarchical level as the abnormality cause of the abnormal task.

14. The device of claim 10, wherein the task log comprises a plurality of log records generated in a chronological order;
the acquiring a task log of an abnormal task comprises:
acquiring a preset number of first log records from a last generated log record; and
in response to, after the feature descriptions of the candidate causes at respective hierarchical levels are compared with the first log records, any of the following conditions being met, then continuing to acquire second log records generated before the first log records:
no target candidate cause matching the first log records is found; and
a target candidate cause matching the first log records is found, and the target candidate cause comprises a child candidate cause.

15. A non-transitory computer-readable storage medium having computer instructions stored thereon, the computer instructions being configured to cause a computer to perform
An abnormal cause localization method, comprising:
acquiring a task log of an abnormal task and auxiliary reference information for abnormal cause localization, the auxiliary reference information comprising feature descriptions of a plurality of candidate causes and a hierarchical relationship of the candidate causes;
comparing, according to the hierarchical relationship of the candidate causes, the feature descriptions of the candidate causes at respective hierarchical levels with the task log, respectively, to obtain at least one target candidate cause matching the task log; and
determining, based on the target candidate cause, an abnormality cause of the abnormal task.

16. The medium of claim 15, wherein the comparing, according to the hierarchical relationship of the candidate causes, the feature descriptions of the candidate causes at respective hierarchical levels with the task log, respectively, to obtain at least one target candidate cause matching the task log comprises:
searching for a first candidate cause at a first hierarchical level;
comparing a feature description of the first candidate cause with the task log, respectively, to obtain a first target candidate cause matching the task log;
searching for, among second candidate causes at a second hierarchical level, a child candidate cause located under the first target candidate cause; and
comparing a feature description of the child candidate cause with the task log to obtain a second target candidate cause matching the task log.

17. The medium of claim 16, further comprising:
in response to there being no first target candidate cause matching the task log in the first candidate cause, then comparing feature descriptions of each of the second candidate causes at the second hierarchical level with the task log, respectively, to search for the second target candidate cause matching the task log.

18. The medium of claim 15, wherein in a case that there are a plurality of target candidate causes at different hierarchical levels, a target candidate cause at a lower hierarchical level is a child candidate cause of a target candidate cause at a higher hierarchical level;
the determining, based on the target candidate cause, an abnormality cause of the abnormal task comprises:
searching for a target candidate cause at a lowest hierarchical level among the plurality of target candidate causes at different hierarchical levels, and using the target candidate cause at the lowest hierarchical level as the abnormality cause of the abnormal task ..

19. The medium of claim 15, wherein the task log comprises a plurality of log records generated in a chronological order;
the acquiring a task log of an abnormal task comprises:
acquiring a preset number of first log records from a last generated log record; and
in response to, after the feature descriptions of the candidate causes at respective hierarchical levels are compared with the first log records, any of the following conditions being met, then continuing to acquire second log records generated before the first log records:
no target candidate cause matching the first log records is found; and
a target candidate cause matching the first log records is found, and the target candidate cause comprises a child candidate cause.

20. The medium of claim 19, further comprising:
in response to, after the feature descriptions of the candidate causes at respective hierarchical levels are compared with the first log records, the target candidate cause matching the first log records being found, and the target candidate cause not comprising the child candidate cause, then stopping acquiring the second log records generated before the first log records.
